(19) United States
(12) Patent Application Publication
(10) Pub. No.: US 2022/0155801 A1
(43) Pub. Date: May 19, 2022

(54) Method for autonomous navigation by integrating sensor data with known aeronautical coordinates using simultaneous localisation and mapping

(71) Applicant: Luuk van Dijk, Zurich (CH)

(72) Inventor: Luuk van Dijk, Zurich (CH)

(21) Appl. No.: 16/950,126

(22) Filed: Nov. 17, 2020

(51) Int. Cl. G05D 1/10; G01C 21/00

(52) U.S. Cl. CPC G05D 1/102; G05D 1/0088; G01C 21/3848; G01C 21/3859

(57) ABSTRACT

A method for autonomous navigation based on integrating sensor data with known aeronautical coordinates in three-dimensional space using simultaneous localisation and mapping methodologies. In particular, a method may include accessing subsets of multiple types of sensor data, aligning subsets of sensor data relative to a global coordinate system based on the multiple types of sensor data to form aligned sensor data, and generating datasets of three-dimensional map data. The method further includes detecting a change in data relative to at least two datasets of the three-dimensional map data and applying the change in data to form updated three-dimensional map data. The change in data may be representative of a state change of an environment at which the sensor data is sensed. The state change of the environment may be related to the presence or absences of an object located therein.

### BACKGROUND OF THE INVENTION

Traditionally, global positioning systems (GPS) have been utilized for navigational systems with a prepopulated database of mapped objects. A navigational system can use this database and its current coordinates to, for example, determine a suitable spot to land or determine a route with the least obstacles. However, there are several risks and drawbacks of using GPS as the basis for a navigational system, including that the OPS coordinates determined degrade, fail or become fundamentally unreliable, and that the stored database of mapped objects may be out of date.

A newer method of navigation, simultaneous localisation and mapping (SLAM), is a process of concurrently building a map of an environment based on stationary features or landmarks within the environment and using this map to obtain estimates of the location of a vehicle (an autonomous cleaner in this example). Simultaneous localisation and mapping can be used as a tool to enable fully autonomous navigation of a vehicle. In essence, the vehicle relies on its ability to extract useful navigation information from data returned by sensors mounted on the vehicle. Typical sensors might include a dead reckoning system (for example, an odometry sensor or inertial measurement system) in combination with a sensor (for example, radar or lidar).

By way of example, a vehicle starts at an unknown location with no a priori knowledge of landmark locations. From relative observations of landmarks, it simultaneously computes an estimate of vehicle location and an estimate of landmark locations. While continuing in motion, the vehicle builds a complete map of landmarks and uses these to provide continuous estimates of the vehicle location. By tracking the relative position between the vehicle and identifiable features in the environment, both the position of the vehicle and the position of the features can be estimated simultaneously. In the absence of external information about the vehicle's position, this algorithm presents an autonomous system with the tools necessary to navigate in unknown environments.

The prospect of deploying a system that can build a map of its environment while simultaneously using that map to localise itself promises to allow vehicles to operate autonomously in unknown environments. However, this is an expensive solution and the data processing overhead is high. One embodiment of this system is a vision based system used in conjunction with SLAM software to form a navigation system for a deterministic cleaner. This technique uses passive sensing to provide a low power and dynamic localisation system. The features acquired by the video camera are input to the SLAM algorithm which is then able to accurately compute the three-dimensional location of each feature and hence start to build a three-dimensional map as the vehicle moves around the space. However, to do this in sufficient detail requires a large number of feature points in the image and the data processing load would be high (proportional to the square of the number of features selected).

Accordingly, the above mentioned navigation systems have hitherto been considered to be prohibitively complex and risky for an autonomous vehicle. It is an object of the invention to provide a navigation system which mitigates at least some of the disadvantages of the conventional navigation systems described above by integrating the best aspects of both GPS navigation with mapped objects and SLAM.

### SUMMARY OF THE INVENTION

According to a first aspect of the present invention, there is now proposed an autonomous navigation system comprising a primary mapping apparatus adapted to detect features within an environment and to create a summary map of the environment including an estimate of a point of current location within the environment; a secondary mapping apparatus adapted to provide a detailed three-dimensional map of the local environment in the vicinity of the point of current location; and a processor adapted to determine navigable points within the environment by combining information from the summary map, the detailed three-dimensional map, and a database of point clouds in a prepopulated three-dimensional map.

The present navigation system is predicated on the realization that, for many applications, adequate navigational performance may be achieved by determining a point of current location within an environment, corresponding said location to known point clouds in a prepopulated three-dimensional map in a database, and comparing sensory data of the current location with the point clouds to determine a navigable route or landing spot.

The present navigation system confers an unexpected advantage in terms of providing reliable navigation within the environment while mitigating risks that prior data gathered on the present location is unreliable or outdated.

In this respect, the database of point clouds and the detailed three-dimensional map in the vicinity of the point of current location mutually support each other to such an extent that a new technical result is achieved.

The foregoing navigation system is advantageous in that the data processing load is reduced in comparison with conventional navigation systems having to construct detailed maps of the environment without prior knowledge. The hardware requirements of the navigation system (processor specification, memory etc.) are correspondingly reduced. In a preferred embodiment, the processor is configured to provide instructions to a motion control system so as to navigate from the point of current location to another navigable point within the environment.

Advantageously, the primary mapping apparatus has an optical sensor adapted to detect the features within the environment and wherein the primary mapping apparatus utilizes a simultaneous localisation and mapping (SLAM) process to create the summary map of the environment.

In one embodiment, the present SLAM system uses a passive optical sensor, for example a simple video camera, and dead reckoning to make visual measurements of an environment and uses pattern processing algorithms to locate visual features in the images acquired by the video camera. These features are input to the SLAM algorithm which is then able to accurately compute the three-dimensional location of the visual features and hence start to build a three-dimensional map of the environment. Navigation within the environment is based on recognized visual features or landmarks.

Upon entering a new environment, the SLAM-enabled navigation system starts updating the prepopulated three-dimensional map through exploration of the environment. By this process, the navigation system confirms and/or updates features in the environment, creates new landmarks there-from, and corrects its position information as necessary using its SLAM-enabled system.

In one embodiment of the invention, objects detected by the navigation systems may be searched for in a database system to determine an exact location to further determine additional “expected landmarks” in the vicinity of the vehicle.

In another embodiment of the invention, “expected landmarks” that are not found, or significantly deviate from an expected location estimate, may be flagged for future analysis. Significant numbers of such “expected landmarks” deviating or being missing may trigger a “lost procedures” protocol, which would prompt the vehicle to begin search for a practical landing space.

In another embodiment of the invention, objects which are detected and were not previously identified in the database of point clouds would be stored in the database as a new short-term point cloud for reference. If the new object detected can be extracted and is large enough to expect some long-term persistence, the SLAM system may store it in the database as a long-term point cloud for future reference, with a different expectation of precision/recall.

1. A navigation system comprising a primary mapping apparatus adapted to detect features within an environment and to create a summary map of the environment including an estimate of a point of current location \-Vi thin the environment; a secondary mapping apparatus adapted to provide a detailed three-dimensional map of the local environment in the vicinity of the point of current location; a database of point clouds in a prepopulated three-dimensional map; and a processor adapted to determine navigable points within the environment by combining information from the summary map, the detailed map, and the database.

2. A navigation system according to claim 1 wherein the processor is configured to provide instructions to a motion control system so as to navigate from the point of current location to another navigable point within the environment.

3. A navigation system according to claim 1, the primary mapping apparatus having an optical sensor adapted to detect the features within the environment and wherein the mapping apparatus utilizes a simultaneous localisation and mapping (SLA1\/I) process to create the summary map of the environment

4. A navigation system according to claims 1 wherein secondary mapping apparatus comprises an imaging apparatus having an imaging sensor and a structured light generator.

5. A navigation apparatus according to claim 4 wherein the imaging apparatus comprises at least one of a spot projector and a pattern projector

6. A navigation apparatus according to claim 4 when directly or indirectly dependent on claim 3 wherein the imaging sensor and the optical sensor comprise a common sensor.

7. A navigation apparatus according to claim 6 wherein the common sensor is one of a video camera, a CMOS camera and a charge-coupled device (CCD).

8. A navigation apparatus according to claim 1 wherein the optical sensor is arranged to have a field of view which includes an upward direction.

9. A navigation apparatus according to claim 8 wherein the optical sensor is arranged, in use, to detect features disposed in a three-dimensional environment, and the mapping apparatus is adapted to create from said detected features a summary map of the environment underlying said three-dimensional environment.

10. A vehicle having a navigation system according to claims 1.

11. An aerial vehicle having a navigation system according to claim 1.

12. An aerial vehicle according to claim 11 comprising a vertical takeoff-and-landing (VTOL) vehicle.

13. A method of controlling an aerial vehicle within an area to be traversed, the aerial vehicle having a variable power requirement and a navigation system adapted to map features in an environment, the method comprising the steps of:
(i) in a first mode of operation, moving the aerial vehicle in a substantially random motion within the area to be traversed whilst concurrently mapping the environment and creating a summary map of the area to be traversed, wherein the vehicle is configured to use a minimum power consumption during said first mode of operation,
(ii) in a second mode of operation, moving the aerial vehicle in at least one direction so as to map the environment in greater detail and to create a complete summary map of the area to be traversed, wherein the vehicle is configured to use increased power consumption during said second mode of operation,
(iii) in a third mode of operation, moving the aerial vehicle in a deterministic motion so as to provide optimum traversing of the space, wherein the vehicle is configured to use an increased power consumption during said third mode of operation.

14. A method according to claim 18 wherein the vehicle is configured only to use sufficient power to traverse the area and map the environment during said first mode of operation.

15. A method according to claim 18 wherein, in use, the aerial vehicle operates in the first, second and third nodes of operation in numerical sequence.

16. A method according to claim 18 wherein the mode within which the aerial vehicle operates is selected in response to a status condition.

17. A method according to claim 18 wherein the status condition is derived from a plurality of variables, each variable having a changeable weighting factor applied thereto so as to optimize the behaviour of the aerial vehicle.

18. A method according to claim 18 wherein the variables are selected from exploration of the area to be traversed, operation of the aerial vehicle, localization within the environment, efficiency of operation and operating time.

19. A method according to any of claim 18 wherein the aerial vehicle reverts to the first mode of operation in the event of a failure in the navigation system.

20. A method according to any of claims 18 wherein the aerial vehicle is a vacuum cleaner and the steps of configuring the vehicle to use minimum and increased power consumption comprise configuring the vacuum cleaner to use minimum and increased suction power, respectively.
